(19) United States
(12) Patent Application Publication
(10) Pub. No.: US 2004/0164449 A1
(43) Pub. Date: Aug. 26, 2004

(54) Disposable vent assembly for a reaction injection molding system

(76) Inventor: Christopher John Feeney, Wallingford, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/373,304

(22) Filed: Feb. 24, 2003

(51) Int. Cl. B29C 45/34

(52) U.S. Cl. 264/240; 425/546; 425/812

(57) ABSTRACT

A vale assembly for a RIM system includes a body which defines a passage, a support structure within the passage, a poppet, and a detachable member which retains the poppet to the support structure. The valve assembly threads into a vent within a mold to provide a communication path for expanded material within the mold cavity. In operation, when a flow through the passage is below a predetermined force the detachable member is retained upon the stem and the valve remains open to provide venting of the mold cavity. Once the mixture expands into a more solid material and expands into the vent and valve assembly, the material flow provides a greater force against the poppet. Eventually, when a predetermined material flow generates a force upon the poppet greater than the predetermined force, the detachable member is detached from the stem and the poppet is pulled from the support structure. The poppet is driven by the material flow into a tapered section of the passage and the passage is blocked to prevent further escape of the densified material from the mold cavity.

This invention was made with government support under Contract No.: DAAH23-00-C-A001 awarded by the Department of the Army. The government therefore has certain rights in this invention.

### BACKGROUND OF THE INVENTION

The present invention relates to Reactive Injection Molding, and more particularly to a vent valve therefore.

Many articles are manufactured by placing a reacting injected polymer mixture into a cavity in a mold wherein the mixture undergoes a physical change. Such molding is generally known as Reactive Injection Molding (RIM) which involves multi-component materials such as urethanes, epoxies, silicone, polyesters, and phenolics, in a liquid form which react within the mold.

The polymer 22 or mixture is dispensed into the mold through a mixing head after which the mixture expands and permanently assumes the shape of the mold cavity. The mold must be adequately vented to allow the gases present and generated within the mold to exit the mold as the mixture reacts and expands.

Failure to adequately vent the mold may result in defective molded articles exhibiting improper densification and/or void formation due to trapped gas. Excess venting of the mold may also result in defective molded articles due to collapse of the mixture prior to curing. Thus, proper venting of a mold is an important factor in producing molded articles of acceptable quality.

Typically, molds include drilled apertures in particular locations to provide vents. Locating, sizing and determining the number of vents is a matter of some skill and is often an iterative procedure. Vents may be added to various locations or other vents may be blocked-off after test runs have been made. Generally, the more complicated the article molded, the greater the number of vents required and the more sensitive the vent location.

During molding operations some mixture expands into the vent and is wasted. It is generally desired to minimize the amount of wasted material due to material expense. The material which expands into the vent must also be later removed from the molded article necessitating additional finishing operation labor and the costs associated therewith.

For relatively high volume parts valves are installed in each vent. A controller operates to close each valve in a particular sequence during curing of the mixture to minimize defects. The valves are quite complicated and expensive which limits usage to high volume production.

In relatively low volume articles and during mold operation testing, tubes are typically inserted into the vents. The mold is vented though the vent and attached tube. As the mixture expands, each tube is individually clamped or bent to prevent further escape of material. Although effective, the tubes provide particular disadvantages such as the reliance on human operator reaction time to control the process. Moreover, a relatively large number of operators are required to visually identify material entering the tube and timely clamping of the tube during the molding operation.

Accordingly, it is desirable to provide effective venting of a RIM mold which minimizes material wastage through venting, reduces the number of operators and is cost effective for low volume articles.

### SUMMARY OF THE INVENTION

The present invention provides a vale assembly for a RIM system. The valve assembly generally includes a body which defines a passage, a support structure within the passage, a poppet, and a detachable member which retains the poppet to the support structure. The valve assembly threads into a vent within a mold to provide a communication path for expanded material within the mold cavity.

The poppet includes a disc and a stem transverse to the disc. The disc is located on the downstream side of the support structure and the detachable member is located on the upstream side of the support structure as defined with regard to flow through the vent and out of the cavity. The retention of the detachable member with the stem determines the force required to close the valve assembly.

In operation, when a flow through the passage is below a predetermined force, the detachable member is retained upon the stem. Such a force may be the force of gasses escaping from the mold cavity. The detachable member abuts the support structure and prevents the flow of gasses from pushing the poppet to a closed position. The passage thereby remains open to provide venting of the mold cavity.

Once the mixture densifies into a more solid form and expands into the vent and valve assembly, the material flow provides a greater force against the disc of the poppet. Eventually, when a predetermined material flow generates a force upon the poppet greater than the predetermined force, the detachable member is detached from the stem. Such a force may be the force of formed and expanded polymer mixture escaping from the mold cavity. The stem is pushed from the support structure and the poppet is driven into the tapered section such that the passage is blocked to prevent further escape of the expanded material from the mold cavity.

The present invention therefore provides effective venting of a RIM mold which minimizes material wastage through venting, reduces the number of operators, and is cost effective for low volume articles.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic representation of a RIM system having a valve assembly designed according to the present invention;

FIG. 2 is an exploded view of a valve assembly;

FIG. 3 is an expanded perspective view of a poppet within the valve assembly;

FIG. 4A is an exploded view of the valve assembly in a first position;

FIG. 4B is an exploded view of the valve assembly in a second position; and

FIG. 4C is an exploded view of the valve assembly utilized as a self sealing injection port.

### DETAILED DESCRIPTION OF THE PREFERRED EMBODIMENT

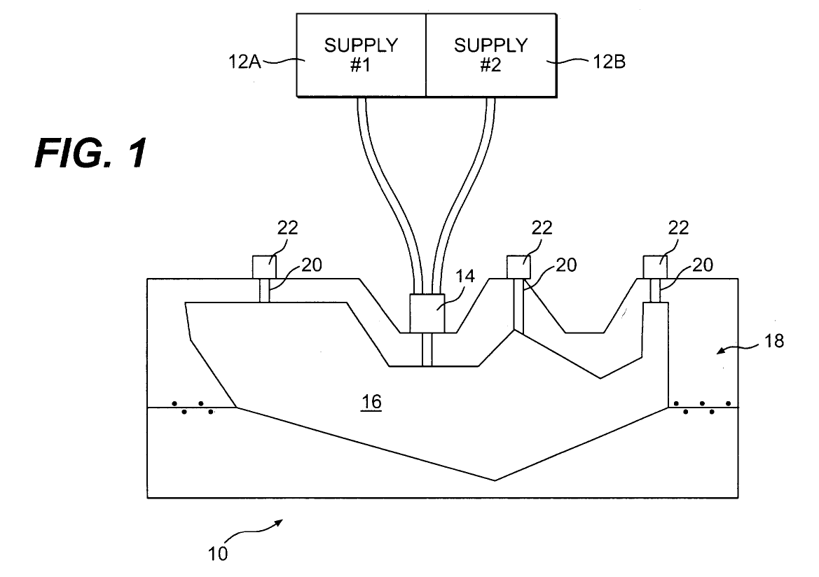

FIG. 1 schematically illustrates a reactive injection molding (RIM) system 10. Multi-component materials are communicated from a multiple of supplies 12A, 12B to a mix head 14 which injects the mixture into a mold cavity 16 of a mold assembly 18. The mixture expands and permanently assumes the shape of the mold cavity 16. The present invention is particularly applicable to complicated molded components such as aircraft canopies, however, other components will benefit from the present invention.

The mold assembly includes a multiple of vents 20 which provide communicate between the mold cavity 16 and the atmosphere. The vents 20 are typically placed in locations within the mold cavity 16 in which gas may be trapped. Such locations are often high points within the mold cavity 16, however, other locations will also benefit from the present invention.

Each vent 20 is preferably threaded to receive a disposable valve assembly 22. The valve assembly 22 provides an escape for the gases present and generated within the mold cavity 16 as the mixture reacts and expands. Once the material reacts and expands to the point in which formed material enters the valve assembly 22, the valve assembly 22 closes to prevent further escape and waste of the mixture. The valve assembly 22 is essentially self closing in response to flow of the mixture which has formed to a predetermined level. “Formed material” is defined herein as material which is at least more densified than a gas.

Generally, the valve assembly 22 of the present invention replaces the conventional method of individually clamping tubes to prevent further escape of material when the material is visually identified as entering the tube. Once the valve assembly 22 closes, it has filled with material and is simply unscrewed from the vent and disposed.

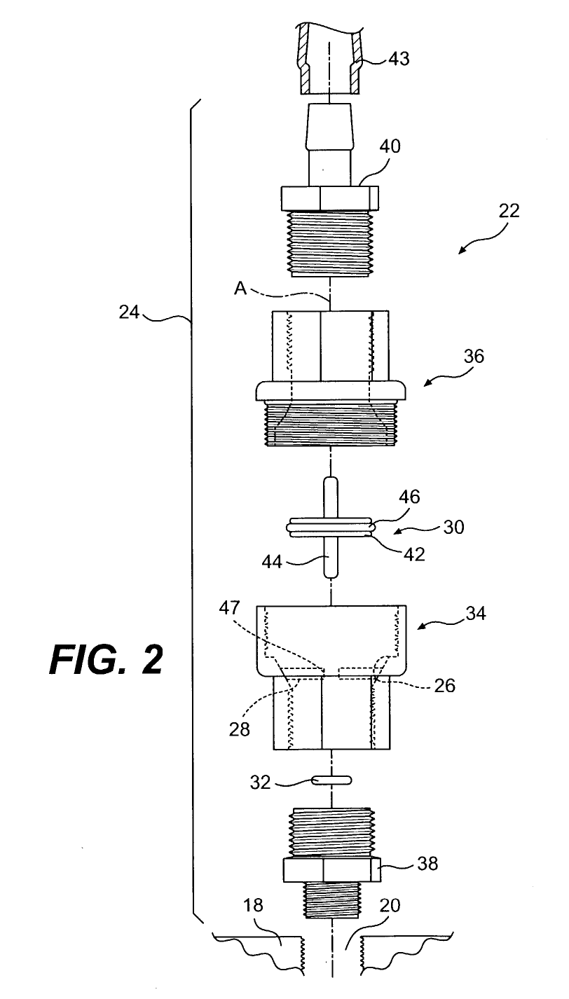

Referring to FIG. 2, the vale assembly 22 is illustrated in exploded view. The valve assembly 22 generally includes a body 24 which defines a passage 26, a support structure 28 within the passage 26, a poppet 30, and a detachable member 32. The passage 26 defines a longitudinal flow axis A. Preferably, the valve assembly 22 is manufacture of non-metallic components to reduce expense.

The body 24 includes a female body member 34 and a male body portion 36 which threads into the female body portion 34. A threaded adapter 38 threads into the female body portion 34 and the threaded vent 20 (FIG. 1). A nipple portion 40 threads into the male body portion 34 to receive a hose 43. The hose 43 provides a communication path for exhausted gasses and possible formed material overflow. The body portions 34, 36, 38 and 40 preferably include wrench flats or the like to assist in assembly. It should be understood that although body portion are disclosed as being threaded together other fastener structures as well as a unitary construction will benefit from the present invention.

The poppet 30 includes a disc 42 and a stem 44 which extends perpendicular thereto. The stem 44 extends from each side of the disc 42 along the axis A and the disc 42 extends transverse thereto. The disc 42 preferably includes a seal 46 extending about the disc 42 periphery to seal against the inner diameter of the passage 26.

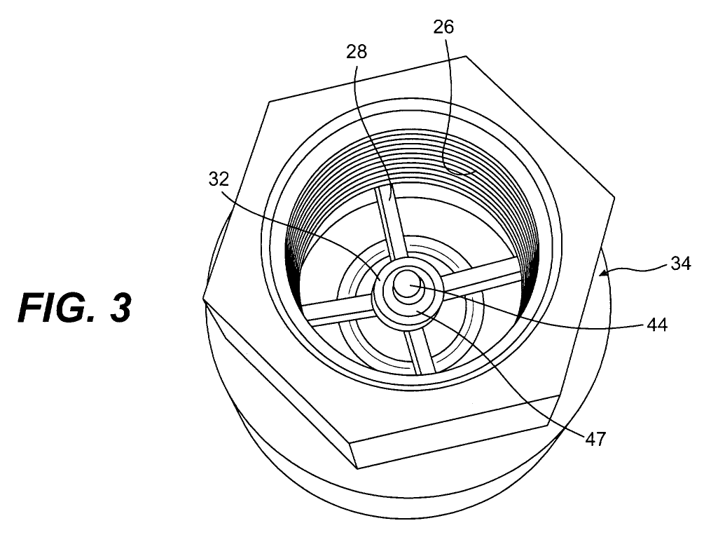

The support structure 28 is preferably a web-like structure (FIG. 3) which includes an aperture 47 located along the axis A. The support structure 28 most preferably minimizes flow through the passage 26. Configuration of the structure 28 may also be utilized to control the material flow which impacts the poppet 30.

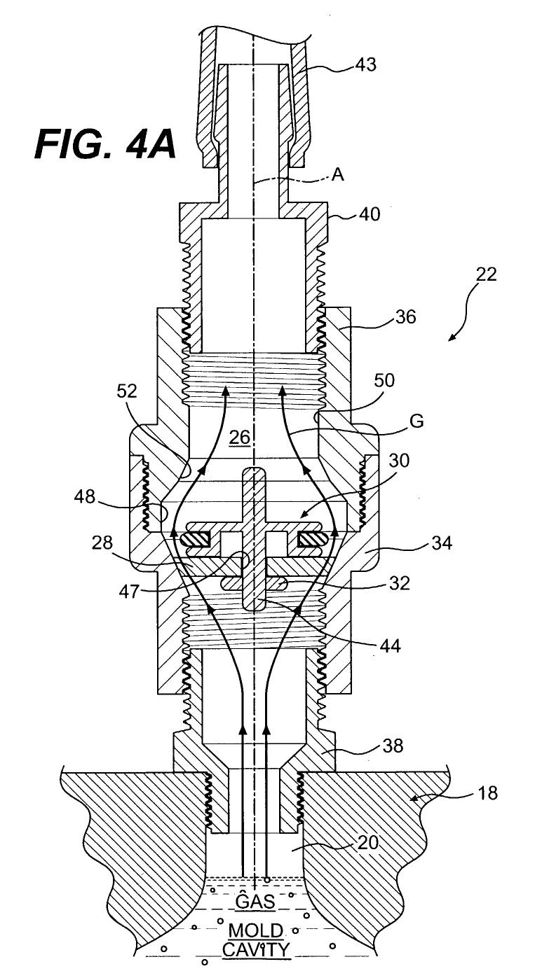

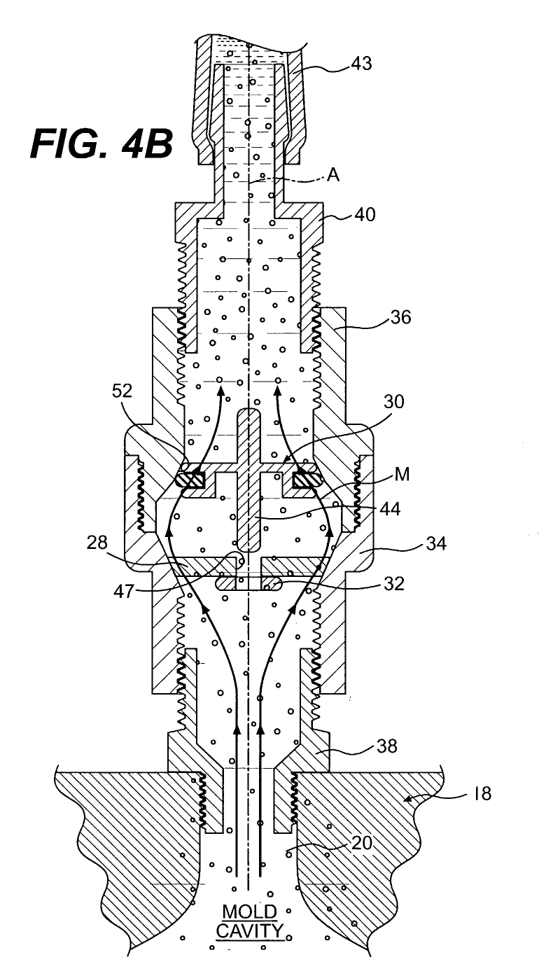

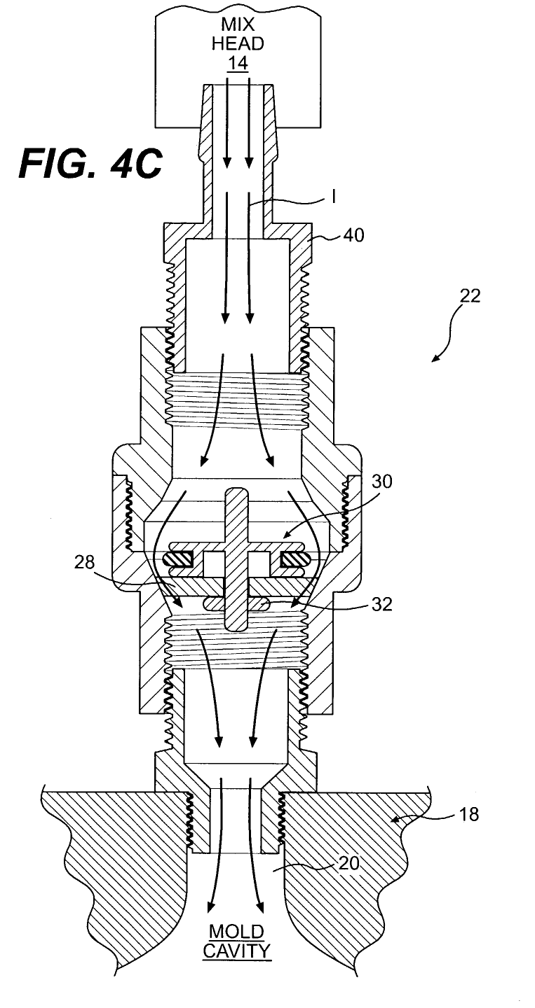

The stem 44 extends through the aperture 47 and is retained thereto by the detachable member 32 (FIG. 3). The disc 42 is located on the downstream side of the support structure 28 and the detachable member 32 is located on the stem 44 on the upstream side of the support structure 28 (FIGS. 4A and 4B). Upstream and downstream are define with regard to vent flow out of the cavity 16 (FIG. 1).

Referring to FIG. 4A, the passage 26 includes a larger passage section 48 having an inner diameter greater than the disc 42 diameter and a smaller passage section 50 smaller than the disc 42 outer diameter. A tapered section 52 preferably transitions the larger passage section 48 to the smaller passage section 50. It should be understood that other passage profiles will also benefit from the present invention.

The larger passage section 48 is located at the intersection of the female body member 34 and the male body portion 36. That is, the poppet 30 is located within the support structure 28 in the female body portion 34 and the detachable member 32 is mounted to the stem 44. The male body portion 34 is then threaded to the female body portion 34 to enclose the poppet 30.

The detachable member 32 is a resilient member such as an O-ring. The retention of the detachable member 32 with the stem 44 determines the force required to close the valve assembly 22. That is, if the detachable member 32 tightly fits upon the stem 44, a relatively large force is required to detach the detachable member 32 from the stem 44. By controlling this interface a desired predetermined flow which will close the valve assembly 22 is achieved.

When a flow through the passage 26 is below the predetermined force the detachable member 32 is retained upon the stem 44. Such a force is preferably the force of gasses escaping from the mold cavity (illustrated schematically at arrows G). The detachable member 32 abuts the support structure 28 and prevents the flow of gasses G from pushing the poppet 30 toward the tapered section 52. The passage 26 thereby remains open to provide venting of the mold cavity 16.

Referring to FIG. 4B, once the mixture expands into a more solid material and expands into the vent 20 and valve assembly 22, the material flow (illustrated schematically at arrow M) provides a greater force against the disc 42 of the poppet 30. Eventually, when a predetermined material flow M is greater the predetermined force, the detachable member 32 is detached from the stem 44. Such a force is preferably the force of formed and expanded mixture material escaping from the mold cavity 16 in the direction of arrow M. The stem 44 is pulled from the aperture 47 in the support structure 28 and the poppet 30 is pushed into the tapered section 52. The disc seals against the tapered section 52. The passage 26 is thereby blocked to prevent further escape of the expanded material from the mold cavity 16. The vent 20 is thereby automatically closed when the material has proper expanded into the area of the vent without the heretofore necessary interaction of an operator.

Typically, some polymer material may flow past the poppet 30 prior to detachment of the detachable member 32 and closure of the valve assembly 22. That is, the valve assembly 22 becomes effectively filled with polymer material. The hose 43 thereby provides a receptacle to retain the overflow. As the valve assembly 22 and hose 43 are relatively inexpensive, the valve assembly 22 is simply unscrewed from the vent 20 and disposed of along with the hose 43.

The valve assembly 22 of the present invention also functions as a self-sealing injection port. The valve assembly 22 permits rapid multi-site injection of large complex parts using a single RIM mix head.

Convention molding procedures attach the RIM mix head to the mold in such a fashion that when it completes its injection cycle it closes and prevents any of the injected material from exiting the cavity. This conventional method requires the mix head to stay in position until the injected polymer has cured. In large complex molds this may be impractical as the mold must be cured within an oven during lengthy heat up cycles. If the mix head must stay in position until cure, the heat up cycle will need to be repeated for each injection.

RIM machines are also typically sized to deposit specific amounts of material. When a part requires more material than the machine can deposit within the reaction profile of the polymer material, a larger RIM machine is required. Larger RIM machines further increase the expense of the process.

The valve assembly 22 of the present invention provides a self sealing injection port which eliminates these problems. The mold may be segregated to permit multiple injections such that the valve assembly 22 operates as self-sealing injection ports to permit the use of existing RIM equipment with negligible impact on total injection times by sequentially attaching the mix head to multiple valve assemblies 22.

Referring to FIG. 4C, the injected material flow is injected into the valve assembly 22 from the nipple portion 40. It should be understood that connectors other than the nipple portion 40 may be preferred for engagement with the mix head. Again, as the body is threaded other connectors may be attached thereto.

The injected material flow (illustrated schematically by arrow I; opposite FIGS. 4A and 4B) now drives the poppet 30 toward the support structure 28. The force of the injected material flow I cannot detach the detachable member 32 from the stem 44 as the disc 42 is retained by the support structure 28. The valve assembly 22 of the present invention therefore also functions as self-sealing input ports. Once the mix head is removed, the valve assembly 22 operates as described above (FIGS. 4A and 4B).

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A vent valve assembly for a reactive injection molded mold system comprising:
a body defining a passage;
a poppet located within said passage, said poppet movable from an open position to a closed position which blocks said passage; and
a detachable member located on said poppet to maintain said poppet in said open position, said detachable member detachable from said poppet in response to a material flow such that said material flow drives said poppet from said open position to said closed position.

2. The vent valve assembly as recited in claim 1, wherein said detachable member comprises a resilient member.

3. The vent valve assembly as recited in claim 1, wherein said detachable member comprises an O-ring.

4. The vent valve assembly as recited in claim 1, further comprising a stem extending from said poppet, said detachable member located upon said stem.

5. The vent valve assembly as recited in claim 4, further comprising a support extending within said passage, said stem extending through said support.

6. The vent valve assembly as recited in claim 1, further comprising,
a support extending within said passage; and
a stem extending from said poppet and through said support, said detachable member located on said stem opposite said support.

7. The vent valve assembly as recited in claim 1, wherein said body comprises a first body portion threaded to a second body portion.

8. The vent valve assembly as recited in claim 1, wherein said body comprises a threaded body portion.

9. The vent valve assembly as recited in claim 1, further comprising a nipple extending from said body.

10. The vent valve assembly as recited in claim 1, wherein said material flow comprises a densified material flow.

11. The vent valve assembly as recited in claim 1, wherein said material flow comprises a densified polymer.

12. A method of venting a reactive injected material mold comprising the steps of:
(1) locating a valve within a vent in a mold;
(2) maintaining the valve in an open position during gas venting of the mold; and
(3) closing the valve in response to a fluid material passage through the valve.

13. A method as recited in claim 12, wherein said step (1) further comprises threading the valve into the vent.

14. A method as recited in claim 12, wherein said step (2) further comprises preventing detachment of a detachable member in response to the gas venting.

15. A method as recited in claim 12, wherein said step (3) further comprises detaching a detachable member in response to the fluid material passage.

16. A method as recited in claim 12, further comprising the steps of:
locating a detachable member to a poppet upstream of the fluid material flow.

17. A method as recited in claim 12, further comprising the steps of:
filling the mold with a reactive mixture through the valve and the vent.

18. A method as recited in claim 12, further comprising the steps of:
locating a detachable member on a poppet within the valve, the detachable member maintaining the poppet in the open position of said step (2); and
detaching the detachable member from the poppet such that the fluid material of said step (3) drives the poppet to obstruct a passage and close the valve.
